(19) United States
(12) Patent Application Publication
(10) Pub. No.: US 2009/0085889 A1
(43) Pub. Date: Apr. 2, 2009

(54) PORTABLE COMMUNICATION DEVICE HAVING A TOUCH KEY

(75) Inventor: Byeong-Bae HYEON, Daejeon (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/237,174

(22) Filed: Sep. 24, 2008

(30) Foreign Application Priority Data
Sep. 27, 2007 (KR) 2007-97335

(51) Int. Cl. G06F 3/045; G06F 3/02

(52) U.S. Cl. 345/174; 345/168

(57) ABSTRACT

A portable communication device having a panel and a touch key with a touch sensor pad integrally attached to the panel is provided. More particularly, the portable communication device includes a panel, a printed circuit board, and a control unit, wherein the portable communication device includes one or more touch sensor pads disposed on the panel for detecting a touch of the panel and for generating respective signals corresponding to the detection, and one or more connection terminals provided with the touch sensor pads, respectively, the one or more connection terminals for electrically connecting to one or more interconnection devices on the printed circuit board, respectively, for applying the signals from the touch sensor pads to the control unit.

### PRIORITY

This application claims the benefit under 35 U.S.C. §119(a) of a Korean patent application filed in the Korean Industrial Property Office on Sep. 27, 2007 and assigned Ser. No. 2007-0097335, the entire disclosure of which is hereby incorporated by reference.

### BACKGROUND OF THE INVENTION

1. Field of the Invention

The present invention relates to a portable communication device having a touch key. More particularly, the present invention relates to a portable communication device with one or more touch keys having a touch sensor pad integrally attached to a panel of the portable communication device.

2. Description of the Related Art

Typically, the term “portable communication device” refers to a device allowing a user to execute wireless communication with a counterpart while being carried by the user. Portable communication devices includes an Hand Held Phone (HHP), a Digital Multimedia Broadcasting (DMB) device, a Cordless Telephone 2nd generation (CT-2) cellular phone, a digital phone, a Personal Communications Service (PCS) device, etc., and are classified into various types on the basis of their external shapes. The above-mentioned conventional portable communication devices include a Liquid Crystal Display (LCD), an antenna device, an input/output device, and a data transceiver.

The input/output device employs a key pad provided with a plurality of keys, and one or more touch keys.

In a conventional resistive touch sensor, the above-mentioned touch key is capable of providing positional information only when two sensors are touched to each other by means of a touch pressure. Consequently, it is necessary to attach a film on top of a touch key panel provided in the portable communication device. However, in a capacitive touch sensor, positional information for a point, where an electric charge (the amount of electricity accumulated on a surface) is discharged, is determined. The capacitive touch sensor is formed as a pad, and attached to the bottom side of a touch key panel.

As illustrated in FIG. 1, the capacitive touch key includes a panel 2 with a surface for printing at least one touch key 2a, the panel 2 being provided in a housing 1 of the portable communication device, a touch sensor pad 3 provided in the housing below the panel 2, the touch sensor pad 3 measuring electrostatic capacitance, a plurality of Light Emitting Diodes (LEDs) 4 provided below the touch sensor pad 3, and a Printed Circuit Board (PCB) 5 with at least one reflection sheet 5a provided below the LEDs 4.

The touch sensor pad 3 is provided with a flexible PCB (FPCB) 3a for measuring an electrostatic capacitance and generating a corresponding signal. The signal may then be applied to a control unit (not shown) of the portable communication device.

Because such a conventional touch key with a touch sensor pad additionally requires a separate FPCB for applying an electric signal of the touch sensor pad to a control unit of the portable communication device, the manufacturing costs for a product of a portable communication device is increased. In addition, because there is a gap between the touch sensor pad and the panel, a large deviation occurs in the touch key. This degrades the touch sensitivity of the touch key, and increases the thickness of the touch key, which impedes an amount the touch key can be reduced in thickness.

In addition, because the touch sensor pad is provided above the LEDs and shields the light of the LEDs, a variation in brightness occurs. Furthermore, because a separate reflection sheet is provided to send the light of the LEDs to the PCB with the touch key, the manufacturing costs for a product of a portable communication device is increased.

Therefore, a portable communication device with a touch sensor pad integrally formed on the panel of the device is needed.

### SUMMARY OF THE INVENTION

An aspect of the present invention is to address at least the above-mentioned problems and/or disadvantages and to provide at least the advantages described below. Accordingly, an aspect of the present invention is to provide a portable communication device having a touch key with a touch sensor pad integrally attached to a panel of the communication device to prevent the occurrence of a gap between the touch sensor pad and the panel, thereby enhancing touch sensitivity, and minimizing a thickness of such a portable communication device.

Another aspect of the present invention is to provide a portable communication device including a touch key having a touch sensor pad integrally attached to a panel to prevent the occurrence of a gap in relation to the panel, thereby enhancing a brightness of LEDs.

Still another aspect of the present invention is to provide a portable communication device having a connection terminal provided with a touch sensor pad attached to a panel, thereby addressing the need for a flexible circuit board provided in an existing touch sensor pad and reducing manufacturing costs, and having one or more LEDs on a printed circuit board, thereby addressing the need for a reflection sheet provided in a conventional portable communication device and reducing manufacturing costs. According to an aspect of the present invention, it is also possible to enhance the ease of assembly of such a portable communication device by reducing the number of parts required for the portable communication device.

According to an aspect of the present invention, a terminal comprising a panel, a printed circuit board, and a control unit is provided. The terminal includes one or more touch sensor pads disposed on the panel for detecting a touch of the panel and for generating respective signals corresponding to the detection, and one or more connection terminals provided with the touch sensor pads, respectively, the one or more connection terminals for electrically connecting to one or more interconnection devices on the printed circuit board, respectively, for applying the signals from the touch sensor pads to the control unit.

According to yet another aspect of the present invention, a terminal comprising a panel, a printed circuit board, and a control unit are provided. The terminal includes one or more touch keys disposed on a front side of the panel, each of the one or more touch keys for receiving a touch, one or more touch sensor pads, disposed on a rear side of the panel at locations corresponding to the one or more touch sensor keys, for detecting electrostatic capacitances associated with the touch received at the one or more touch keys and for generating respective signals corresponding to the detection, and one or more connection terminals provided with the touch sensor pads, respectively, the one or more connection terminals for electrically connecting to one or more interconnection devices on the printed circuit board, respectively, for applying the signals from the touch sensor pads to the control unit.

According to yet another aspect of the present invention, a terminal comprising a panel, a printed circuit board, and a control unit are provided. The terminal includes one or more touch keys disposed on a front side of the panel, each of the one or more touch keys for receiving a touch, one or more touch sensor pads, disposed on a rear side of the panel at locations corresponding to the one or more touch sensor keys, for detecting electrostatic capacitances associated with the touch received at the one or more touch keys and for generating respective signals corresponding to the detection, wherein the one or more touch sensor pads are disposed on the panel substantially without a gap between the one or more touch sensor pads and the panel, one or more connection terminals provided with the touch sensor pads, respectively, the one or more connection terminals for electrically connecting to one or more interconnection devices on the printed circuit board, respectively, for applying the signals from the touch sensor pads to the control unit, wherein the one or more connection terminals each comprises a connection pin, and a housing, wherein the housing is formed with one or more through-holes in a surface of the housing, through which the connection terminals extend, respectively.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description taken in conjunction with the accompanying drawings, in which:

FIG. 1 is an exploded perspective view illustrating a construction of a portable communication device with conventional touch keys;

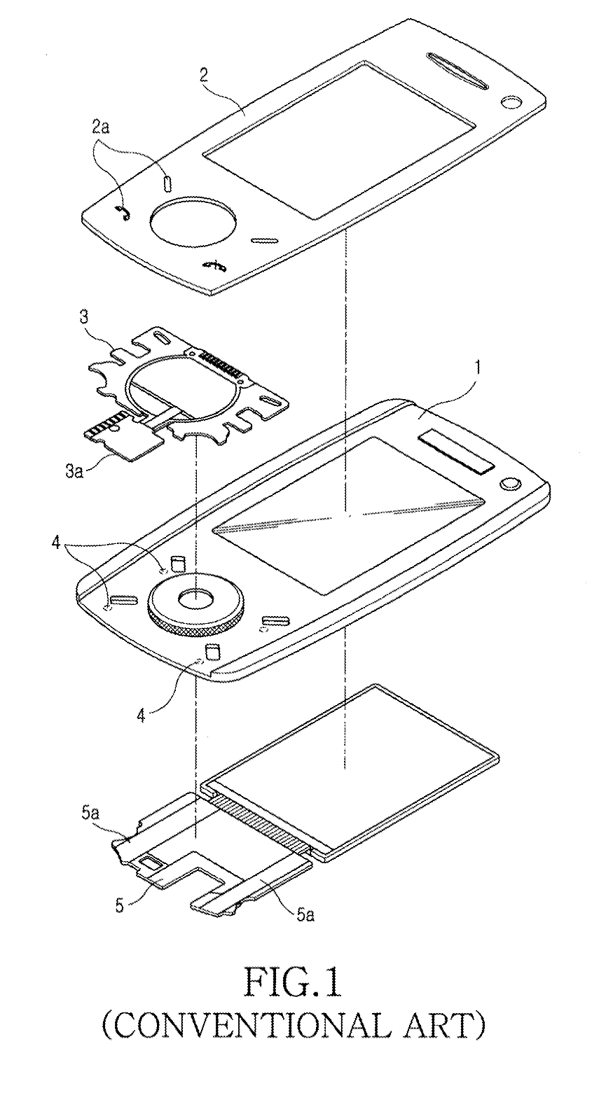

FIG. 2 is an exploded perspective view illustrating a construction of a portable communication device with touch keys according to an exemplary embodiment of the present invention;

FIG. 3 is a schematic view illustrating a rear side of a panel of a portable communication device according to an exemplary embodiment of the present invention; and

FIG. 4 is a top plan view illustrating a printed circuit board of a portable communication device with touch keys according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

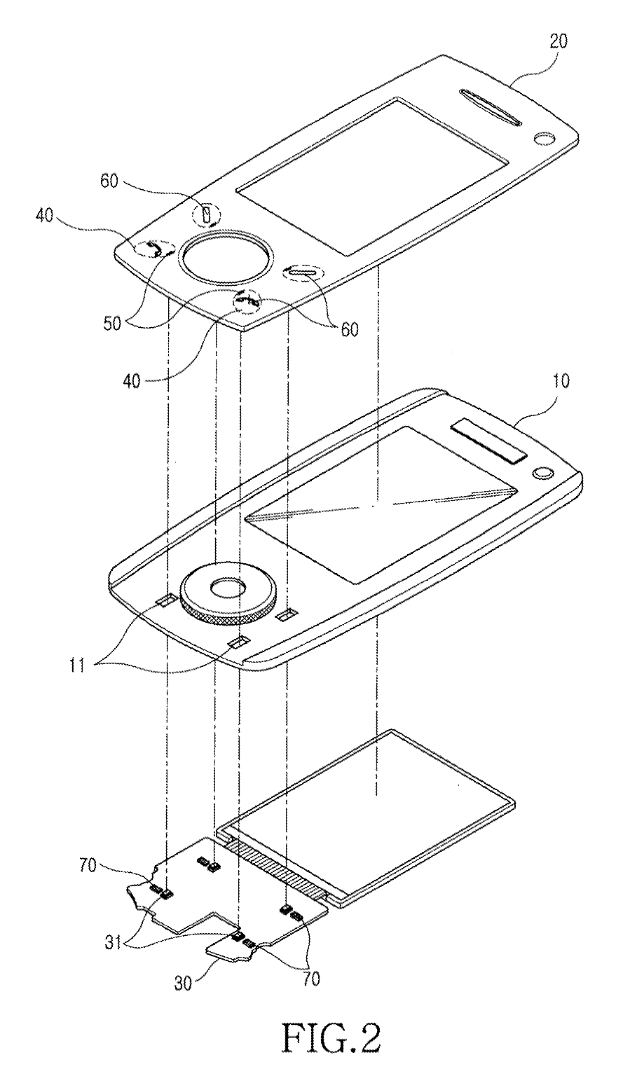

As illustrated in FIGS. 2 to 4, the portable communication device with one or more touch keys includes a housing 10, a panel 20 providing a surface with touch keys 60, a printed circuit board 30, one or more touch sensor pads 40, and one or more connection terminals 50. The touch keys 60 may be formed with the panel 20, printed thereon, or may be formed in any other manner in which they are visually differentiated from the remaining portions of the panel 20.

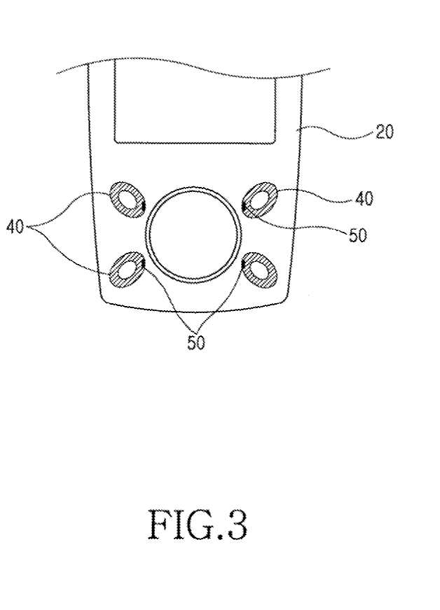

As illustrated in FIG. 3, the touch sensor pads 40 are integrally attached to the rear side of the panel to measure an electrostatic capacitance when the panel 20 is touched and generate a corresponding signal.

As illustrated in FIG. 2, the connection terminals 50 are provided on the touch sensor pads 40, respectively, so that they are electrically connected with connecting terminals 31 on the printed circuit board 30 to apply signals from the touch sensor pads 30 to a control unit (not shown) of the portable communication device.

As illustrated in FIG. 3, the touch sensor pads 40 are independently positioned below the touch keys 60 printed on the panel 20. Each of the connecting terminals 31 is formed by a connector pin to be electrically connected with any of the connection terminals 50.

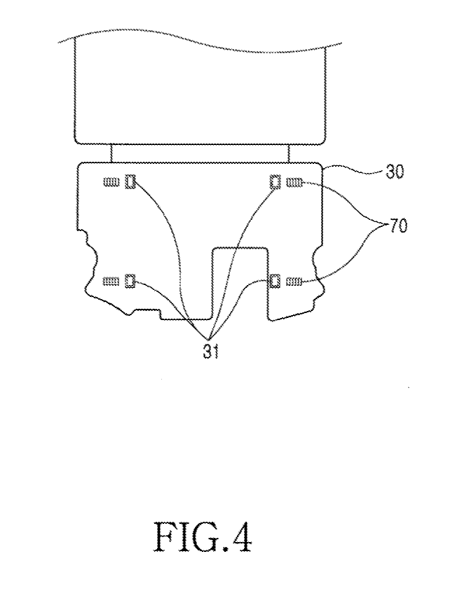

As illustrated in FIG. 4, the printed circuit board 30 is provided with one or more LEDs 70 to transmit light to the touch keys 60 of the panel 20.

Now, an assembly process of a portable communication device with one or more touch keys according to an exemplary embodiment of the present invention configured as described above will be described in more detail with reference to FIGS. 2 to 4.

As illustrated in FIG. 2, the portable communication device with one or more touch keys includes a housing 10, a panel 20 providing a surface for disposing the touch keys 60 thereon, a printed circuit board 30, one or more touch sensor pads 40, one or more connection terminals 50, and one or more connecting terminals 31.

As shown in FIG. 3, the touch sensor pads 40 are integrally attached to the panel at the rear side of the touch keys 60, respectively. Here, the touch sensor pads 40 are independently attached to the touch keys 60 of the panel 20, respectively.

At this time, the touch sensor pads 40 are attached to the panel 20 substantially without a gap there between.

If a subassembly according to this construction is assembled as the portable communication device as illustrated in FIG. 2, the connection terminals 50, which are formed on the touch sensor pads 40, respectively, are electrically connected to the connecting terminals 31 on the printed circuit board 30 through one or more through-holes 11 formed in the housing 10 of the portable communication device, respectively.

Here, each of the connecting terminals 31 is formed by a connector pin, so that the connecting terminals 31 are inserted into the connection terminals 50 of the touch sensor pads 40 while coming into contact with the connection terminals 50, respectively.

At this time, as shown in FIG. 4, the printed circuit board 30 is provided with one or more LEDs 70. Because the LEDs 70 are provided on the printed circuit board 30, it is not necessary to provide a reflection sheet, which conventionally would have been provided on such a printed circuit board 30. Thereby, it is possible to reduce the manufacturing costs of a product of such a portable communication device.

In this condition, if a user touches the touch key-printed surface provided on the panel 20, the variation of the electrostatic capacitance of the touch sensor pads 50 is measured, corresponding electric signals are generated and the generated electric signals are applied to a control unit (not shown) of the portable communication device through the connection terminals 50 and the interconnection devices 31.

Because the touch sensor pads 40 are attached to the rear side of the panel 20, an existing flexible circuit is not needed and thereby it is possible to reduce the manufacturing costs of a product of such a portable communication device. Furthermore, with the touch sensing pads 40 attached to the rear side of panel 20, it is possible to prevent an occurrence of a deviation, thereby enhancing the touch sensitivity of the touch keys 60.

While a portable communication device has been described above as an example, other exemplary embodiments of the present invention may be implemented in any device that receives tactile input from a user.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A terminal comprising a panel, a printed circuit board, and a control unit, the terminal comprising:
one or more touch sensor pads disposed on the panel for detecting a touch of the panel and for generating respective signals corresponding to the detection; and
one or more connection terminals provided with the touch sensor pads, respectively, the one or more connection terminals for electrically connecting to one or more interconnection devices on the printed circuit board, respectively, for applying the signals from the touch sensor pads to the control unit.

2. The terminal as claimed in claim 1, further comprising one or more touch keys disposed on a front side of the panel, wherein the one or more touch sensor pads are disposed on a rear side on the panel.

3. The terminal as claimed in claim 2, wherein the location of each of the one or more touch sensor pads on the rear side of the panel substantially corresponds to the location of a respective touch key on the front side of the panel.

4. The terminal as claimed in claim 1, wherein each of the connection terminals comprises a connection pin.

5. The terminal as claimed in claim 1, further comprising one or more Light Emitting Diodes (LEDs) disposed on the printed circuit board.

6. The terminal as claimed in claim 5, wherein light generated by the one or more Light Emitting Diodes (LEDs) illuminates one or more touch keys disposed on the panel.

7. The terminal as claimed in claim 1, further comprising a housing, wherein the housing is formed with one or more through-holes in a surface of the housing, through which the connection terminals extend, respectively.

8. The terminal as claimed in claim 1, wherein the one or more touch sensor pads when detecting a touch of the panel, measures an electrostatic capacitance associated with the touching of the panel.

9. The terminal as claimed in claim 1, wherein the terminal is a portable communication device.

10. The terminal as claimed in claim 1, wherein the one or more touch sensor pads are disposed on the panel substantially without a gap between the one or more touch sensor pads and the panel.

11. The terminal as claimed in claim 1, wherein the one or more touch sensor pads are integrally attached to the panel.

12. A terminal comprising a panel, a printed circuit board, and a control unit, the terminal comprising:
one or more touch keys disposed on a front side of the panel, each of the one or more touch keys for receiving a touch;
one or more touch sensor pads, disposed on a rear side of the panel at locations corresponding to the one or more touch sensor keys, for detecting electrostatic capacitances associated with the touch received at the one or more touch keys and for generating respective signals corresponding to the detection; and
one or more connection terminals provided with the touch sensor pads, respectively, the one or more connection terminals for electrically connecting to one or more interconnection devices on the printed circuit board, respectively, for applying the signals from the touch sensor pads to the control unit.

13. The terminal as claimed in claim 12, wherein each of the connection terminals comprises a connection pin.

14. The terminal as claimed in claim 12, further comprising one or more Light Emitting Diodes (LEDs) disposed on the printed circuit board.

15. The terminal as claimed in claim 12, further comprising a housing, wherein the housing is formed with one or more through-holes in a surface of the housing, through which the connection terminals extend, respectively.

16. The terminal as claimed in claim 12, wherein the terminal is a portable communication device.

17. The terminal as claimed in claim 12, wherein a number of the one or more touch keys is the same as the number of one or more touch sensor pads.

18. The terminal as claimed in claim 12, wherein the one or more touch sensor pads are disposed on the panel substantially without a gap between the one or more touch sensor pads and the panel.

19. The terminal as claimed in claim 12, wherein the one or more touch sensor pads are integrally attached to the panel.

20. The terminal as claimed in claim 12, wherein a number of the one or more touch keys is the same as the number of one or more touch sensor pads.
